(19) United States
(12) Patent Application Publication
(10) Pub. No.: US 2017/0201994 A1
(43) Pub. Date: Jul. 13, 2017

(54) SUBFRAME STRUCTURE AND HARQ OPERATING METHOD OF WIRELESS COMMUNICATION SYSTEM

(71) Applicant: ELECTRONICS AND TELECOMMUNICATIONS RESEARCH INSTITUTE, Daejeon (KR)

(72) Inventors: Soon Yong LIM, Daejeon (KR); Kwang Ryul JUNG, Daejeon (KR)

(73) Assignee: ELECTRONICS AND TELECOMMUNICATIONS RESEARCH INSTITUTE, Daejeon (KR)

(21) Appl. No.: 15/399,354

(22) Filed: Jan. 5, 2017

(30) Foreign Application Priority Data
Jan. 12, 2016 (KR) 10-2016-0003578

(51) Int. Cl. H04W 72/04; H04L 1/18; H04L 5/00; H04L 27/26

(52) U.S. Cl. CPC H04W 72/0453; H04L 27/2613; H04L 1/1812; H04L 5/0055

(57) ABSTRACT

Provided is a subframe structure of a wireless communication system, including a plurality of short frames defined as n (n<12, n is a natural number) OFDM symbol periods, wherein a transmission time interval (TTI) is determined based on the plurality of short frames.

### CROSS-REFERENCE TO RELATED APPLICATIONS

This application claims priority to and the benefit of Korean Patent Application No. 10-2016-0003578 filed in the Korean Intellectual Property Office on Jan. 12, 2016, the entire contents of which are incorporated herein by reference.

### TECHNICAL FIELD

The present invention relates to a subframe structure and an HARQ operating method of a wireless communication system.

### BACKGROUND ART

In the future, it is predicted that various real-time interactive multimedia services including augmented reality, virtual reality, a real-time online game, and the like will increase. Users who use the services need to provide a low-delay 5G wireless communication service in order to experience natural interaction. In general, auditory information which human feels at the time of receiving visual and auditory information through media needs to be transferred within approximately 100 ms and visual information needs to be transferred within a permissible delay time of approximately 10 ms. When a longer delay time is generated in transferring the information, people feel unnaturalness for the corresponding service.

It is also predicted that new wireless communication services requiring end-to-end latency within a maximum of several ms will be created in various wireless communication application areas including traffic, sports, education, a medical service, manufacturing, and the like. For example, V2V communication and V2I communication require extremely short wireless communication latency in order to provide a traffic safety service. Further, wireless communication technology is required to be provided, which can guarantee very short latency similarly to the traffic safety service in order to guarantee high reliability and stability of a remote operation through a robot, and the like when an injured person moves under an emergency situation.

### SUMMARY OF THE INVENTION

The present invention has been made in an effort to provide a subframe structure and an HARQ operating method of a wireless communication system, which can guarantee low latency characteristics.

The technical objects of the present invention are not limited to the aforementioned technical objects, and other technical objects, which are not mentioned above, will be apparently appreciated to a person having ordinary skill in the art from the following description.

An exemplary embodiment of the present invention provides a subframe structure of a wireless communication system, including a plurality of short frames defined as n (n<12, n is a natural number) OFDM symbol periods, wherein a transmission time interval (TTI) is determined based on the plurality of short frames.

The n may be 2.

The subframe may include a downlink subframe or an uplink subframe.

The downlink subframe may include 6 data short frames and 1 legacy short frame.

A first OFDM symbol of two OFDM symbols included in each of 6 data short frames may include control information of a corresponding data short frame.

The uplink subframe may include 7 data short frames.

Each of 7 data short frames may include information for transferring uplink control information (UCI).

The subframe may be defined in a partial area in an available channel bandwidth.

The subframe may be defined as a time period of 1 ms.

Another exemplary embodiment of the present invention provides an HARQ operating method of a wireless communication system using a subframe structure including a plurality of short frames defined as 2 OFDM symbol periods, in which a transmission time interval (TTI) is determined based on the plurality of short frames, the method including: receiving first downlink data through the physical downlink shared channel (PDSCH) at a first short frame among a plurality of short frames; transmitting an ACK/NACK message corresponding to the first downlink data through the physical uplink control channel (PUCCH) at a second short frame at which a four-short frame interval elapsed from the first short frame; and receiving second downlink data through the PDSCH at a third short frame at which the four-short frame interval elapsed from the second short frame, wherein when the third short frame is a legacy short frame, a next short frame is set as the third short frame.

The subframe may be a downlink subframe.

The downlink subframe may include 6 data short frames and 1 legacy short frame.

A first OFDM symbol of two OFDM symbols included in each of 6 data short frames may include control information of a corresponding data short frame.

Yet another exemplary embodiment of the present invention provides an HARQ operating method of a wireless communication system using a subframe structure including a plurality of short frames defined as 2 OFDM symbol periods, in which a transmission time interval (TTI) is determined based on the plurality of short frames, including: transmitting first uplink data through a physical uplink shared channel (PUSCH) at a first short frame among a plurality of short frames; and receiving a downlink control information (DCI) message or an ACK/NACK message corresponding to the first uplink data through a physical uplink control channel (PDCCH) or a physical HARQ indicator channel (PHICH) at a second short frame at which a four-short frame interval elapsed from the first short frame, wherein when the second short frame is a legacy short frame, a next short frame is set as the second short frame.

The subframe may be an uplink subframe.

The uplink subframe may include 7 data short frames.

Each of 7 data short frames may include information for transferring uplink control information (UCI).

According to exemplary embodiments of the present invention, a subframe structure and an HARQ operating method of a wireless communication system can guarantee low latency characteristics of the wireless communication system.

Meanwhile, effects which can be obtained in the present invention are not limited to the aforementioned effects and other unmentioned effects will be clearly understood by those skilled in the art from the following description.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a structure of a radio frame which can be used in exemplary embodiments of the present invention.

FIG. 2 is a diagram illustrating a resource grid for one downlink slot which can be used in the exemplary embodiments of the present invention.

FIG. 3 illustrates a downlink subframe structure according to the exemplary embodiment of the present invention.

FIG. 4 illustrates an uplink subframe structure according to the exemplary embodiment of the present invention.

FIGS. 5A and 5B illustrate band allocation of a subframe according to the exemplary embodiment of the present invention.

FIG. 6 illustrates the wireless communication system according to the exemplary embodiment of the present invention.

FIG. 7 is a flowchart illustrating a downlink HARQ operating method of a wireless communication system according to another exemplary embodiment of the present invention.

FIG. 8 is a diagram illustrating a downlink HARQ operation of the wireless communication system according to the exemplary embodiment of the present invention.

FIG. 9 is a flowchart illustrating an uplink HARQ operating method of the wireless communication system according to the exemplary embodiment of the present invention.

FIG. 10 is a diagram illustrating the uplink HARQ operation of the wireless communication system according to the exemplary embodiment of the present invention.

FIG. 11 is a block diagram of a computing system executing the HARQ operating method of the wireless communication system according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is noted that although the same components are illustrated in different drawings, the same components are designated by the same reference numerals as possible. In describing the exemplary embodiments of the present invention, when it is determined that the detailed description of the known components and functions related to the present invention may obscure understanding of the exemplary embodiments of the present invention, the detailed description thereof will be omitted.

Terms such as first, second, A, B, (a), (b), and the like may be used in describing the components of the exemplary embodiments of the present invention. The terms are only used to distinguish a component from another component, but nature or an order of the component is not limited by the terms. Further, if it is not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present application.

In the following description, it is assumed that mobile or fixed user terminal apparatuses including user equipment (UE), a mobile station (MS), and the like and may include devices including a tablet personal computer (PC), a smart phone, a digital camera, a portable multimedia player (PMP), a media player, a portable game terminal, and a personal digital assistant (PDA) in addition to a mobile communication terminal are collectively called a terminal. It is assumed that predetermined nodes of a network end, which communicate with the terminal, such as Node B, eNode B, Base Station, and the like are collectively called a base station.

In a wireless communication system, the terminal (user equipment) may receive information from the base station through a downlink and the terminal may also transmit information to the base station through an uplink. Information transmitted or received by the terminal may include data and various control information and various physical channels are present according to a type and a purpose of the information transmitted or received by the terminal.

Various exemplary embodiments of the present invention may be developed based on a long term evolution (LTE) communication system. Therefore, hereinafter, first, a frame configuration of the LTE communication system will be described.

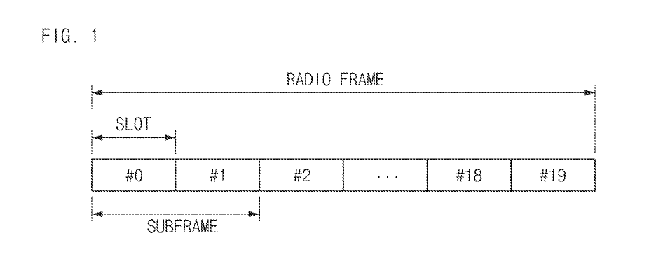

FIG. 1 is a diagram illustrating a structure of a radio frame which can be used in exemplary embodiments of the present invention.

Referring to FIG. 1, the radio frame is constituted by 10 subframes and one subframe is constituted by two slots. The length of one subframe may be defined as 1 ms and the length of one slot may be defined as 0.5 ms.

One slot includes a plurality of orthogonal frequency division multiplexing (OFDM) symbols in a time domain and includes multiple resource blocks (RBs) in a frequency domain. The OFDM symbol is used for expressing one symbol period in a 3GPP LTE system using an orthogonal frequency division multiplexing access (OFDMA) scheme in a downlink. That is, the OFDM symbol may be referred to as an SC-FDMA symbol or symbol period according to a multiple-access scheme. The RB includes a plurality of consecutive subcarriers in one slot per resource allocation.

The structure of the radio frame of FIG. 1 is just an example and the number of subframes included in the radio frame, the number of slots included in the subframe, and the number of OFDM symbols included in the slot may be variously modified.

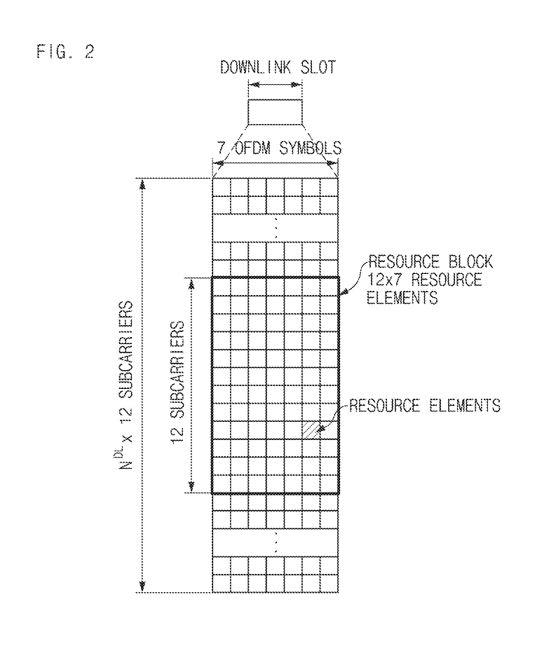

FIG. 2 is a diagram illustrating a resource grid for one downlink slot which can be used in the exemplary embodiments of the present invention.

Referring to FIG. 2, the downlink slot includes the plurality of OFDM symbols in the time domain. In FIG. 2, it is exemplarily described that one downlink slot includes 7 OFDM symbols and one resource block (RB) includes 12 subcarriers in the frequency domain.

Each element on a resource grid is referred to as a resource element (RE) and one resource block (RB) includes 12×7 resource elements (REs). NDL which is the number of resource blocks included in the downlink slot depends on a downlink transmission bandwidth set in a cell.

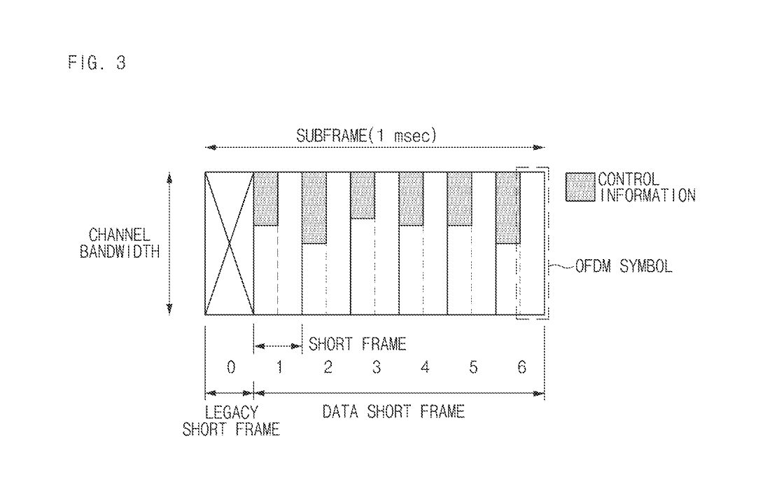

FIG. 3 illustrates a downlink subframe structure according to the exemplary embodiment of the present invention.

Referring to FIG. 3, the downlink subframe structure of the wireless communication system according to the exemplary embodiment of the present invention may include a plurality of short frames defined as n (n<12, n is a natural number) OFDM symbol periods and a transmission time interval (TTI) may be determined based on the plurality of short frames. For example, the TTI may be occupied by one short frame.

In FIG. 3, it is exemplarily illustrated that n is 2, but the present invention is not limited thereto. Hereinafter, the downlink subframe structure will be described by assuming that n is 2 for easy description.

The downlink subframe may be defined as a time interval of 1 ms (msec). The downlink subframe may include 14 OFDM symbols and when n is 2 and the downlink subframe may be constituted by 7 short frames.

7 short frames may include 6 data short frames and 1 legacy short frame. For example, the data short frame may mean a short frame for data transmission and the legacy short frame may mean a short frame for downlink control.

Each data short frame may include 2 OFDM symbols and include control information of the data short frame corresponding to a first OFDM symbol among two OFDM symbols. Herein, the corresponding data short frame may mean the data short frame including the first OFDM symbol.

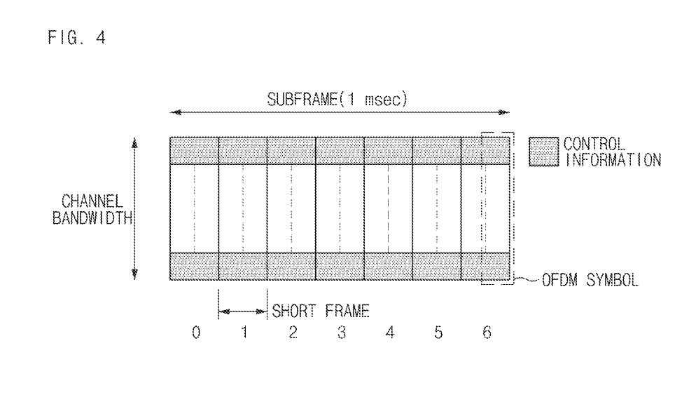

FIG. 4 illustrates an uplink subframe structure according to the exemplary embodiment of the present invention.

Referring to FIG. 4, it is exemplarily illustrated that n is 2 similarly to FIG. 3, but the present invention is not limited thereto. Hereinafter, the uplink subframe structure will be described by assuming that n is 2 for easy description.

The uplink subframe may be defined as a time interval of 1 ms (msec). The uplink subframe may include 14 OFDM symbols and when n is 2 and the uplink subframe may be constituted by 7 data short frames. For example, the data short frame may mean a short frame for data transmission.

Each data short frame may include 2 OFDM symbols and the two OFDM symbols may include information for uplink control information transmission. Herein, the corresponding data short frame may mean the data short frame including two OFDM symbols.

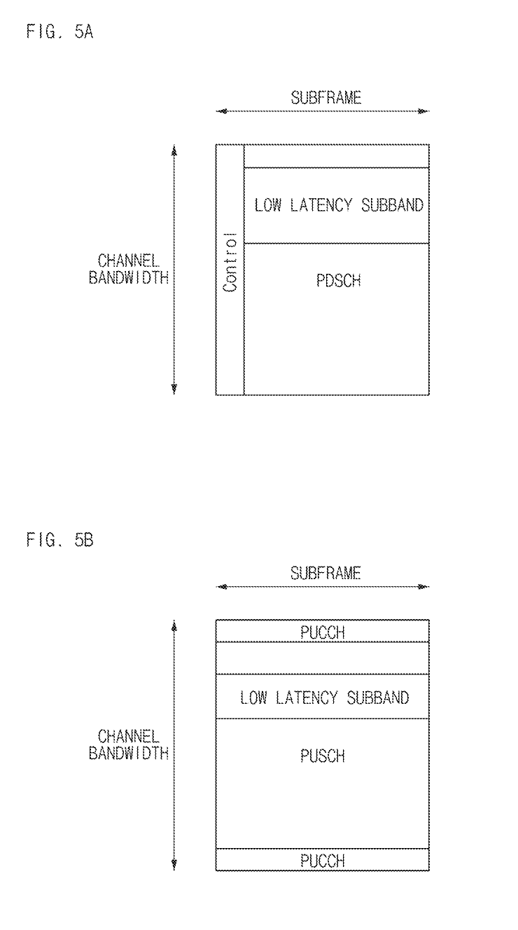

FIGS. 5A and 5B illustrate band allocation of a subframe according to the exemplary embodiment of the present invention.

Referring to FIGS. 5A and 5B, the downlink subframe and the uplink subframe may be defined in a partial area of an allocated channel bandwidth (alternatively, an available channel bandwidth) in a subband form. Besides, in the case of the downlink, a control region CONTROL and a physical downlink shared channel (PDSCH) region may be further defined and in the case of the uplink, physical uplink control channel (PUCCH) and physical uplink shared channel (PUSCH) regions may be further defined.

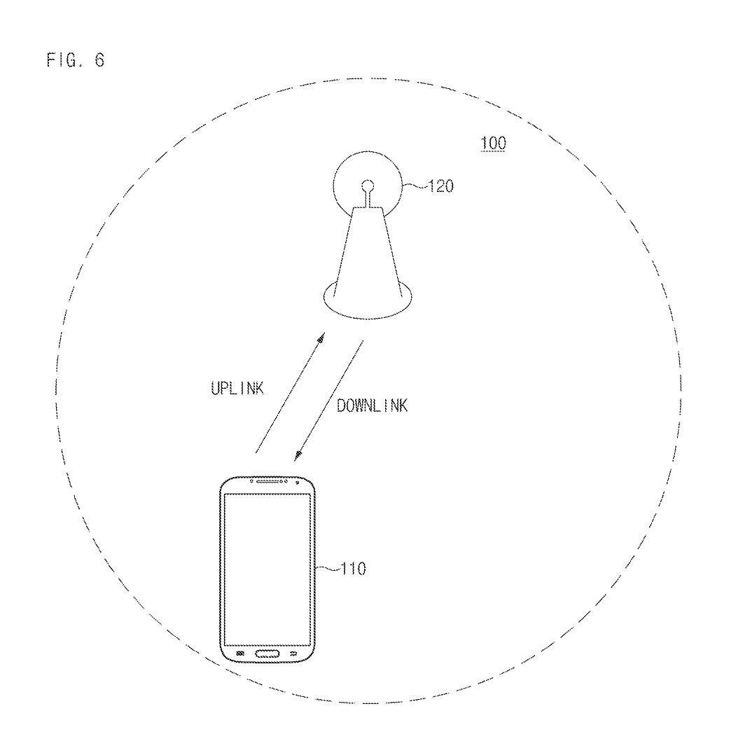

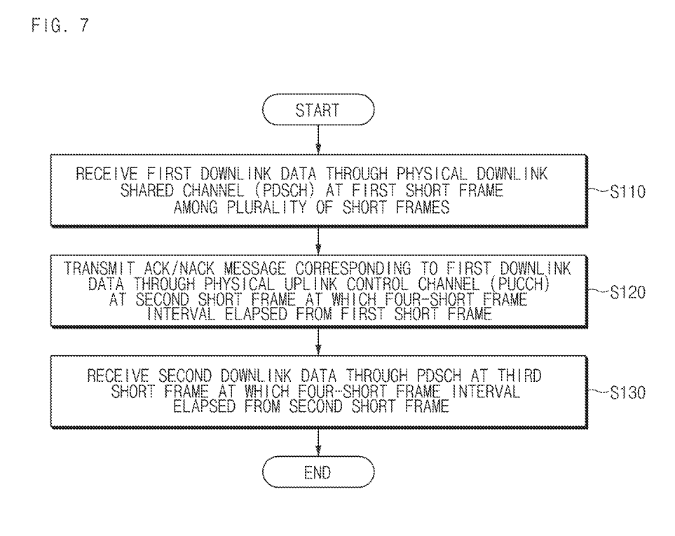

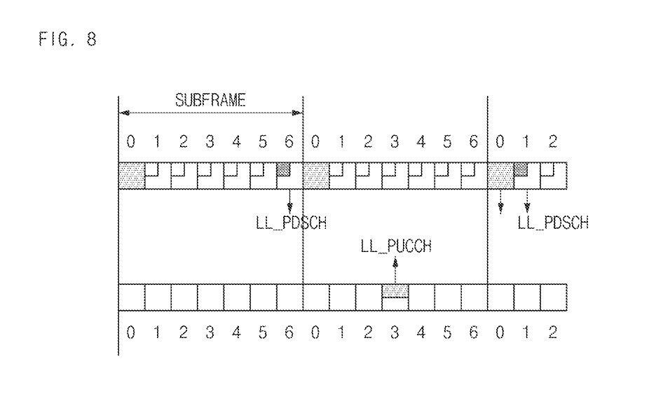

FIG. 6 illustrates the wireless communication system according to the exemplary embodiment of the present invention. FIG. 7 is a flowchart illustrating a downlink HARQ operating method of a wireless communication system according to another exemplary embodiment of the present invention. FIG. 8 is a diagram illustrating a downlink HARQ operation of the wireless communication system according to the exemplary embodiment of the present invention.

First, referring to FIG. 6, the wireless communication system 100 according to the exemplary embodiment of the present invention may include a terminal 110 and a base station 120. Hereinafter, data transmission between the terminal 110 and the base station 120 through the downlink and the uplink and the resulting HARQ transmitting method will be described and the wireless communication system 100 will be described by assuming that an HARQ operation is performed by using the subframe structure described with reference to FIGS. 3 and 4.

First, when HARQ transmission is described, in the case where the wireless communication system 100 transmits and receives data, a receiving end needs to notify to a transmitting end whether to successfully receive the data. When the data is successfully received, the transmitting end transmits new data by transmitting an acknowledgment (ACK) and when the data is unsuccessfully received, the transmitting end retransmits the data by transmitting a negative acknowledgment (NACK). Such an operation is referred to as an automatic repeat and request (ARQ). Hybrid ARQ (HARQ) is proposed by combining the ARQ operation and a channel coding technique.

Referring to FIG. 7, the HARQ operating method of the wireless communication system according to the exemplary embodiment of the present invention may include receiving first downlink data among a plurality of short frames through the physical downlink shared channel (PDSCH) at a first short frame (S110), transmitting an ACK/NACK message corresponding to the first downlink data through the physical uplink control channel (PUCCH) at a second short frame at which a four-short frame interval elapsed from the first short frame (S120), and receiving second downlink data through the PDSCH at a third short frame at which the four-short frame interval elapsed from the second short frame (S130) and when the third short frame is a legacy short frame, a next short frame may be set as the third short frame.

Hereinafter, steps S110 to S130 will be described in more detail with reference to FIGS. 6 and 8.

In step S110, the terminal 110 may receive the first downlink data to the first short frame (e.g., short frame #6) from the base station 120 through a low latency PDSCH (LL_PDSCH). Herein, the LL_PDSCH may mean that low latency characteristics which the wireless communication system 100 according to the exemplary embodiment of the present invention may obtain by using the subframe structure described with reference to FIGS. 3 and 4 are reflected.

In step S120, the terminal 110 may transmit the ACK or NACK message to the base station 120 through a low latency PUCCH (LL_PUCCH) as a response to the first downlink data at the second short frame (e.g., short frame #3) at which the fourth short frame interval elapsed from the first short frame (e.g., short frame #6). Herein, the LL_PUCCH may mean that the low latency characteristics which the wireless communication system 100 according to the exemplary embodiment of the present invention may obtain by using the subframe structure described with reference to FIGS. 3 and 4 are reflected.

In step S130, the terminal 110 may receive the second downlink data through the LL_PDSCH at the third short frame at which the four-short frame interval elapsed from the second short frame (e.g., short frame #3). Herein, the third short frame may be set as short frame #1. That is, the third short frame at which the four-short frame interval elapsed from the second short frame (e.g., short frame #3) is short frame #0, but short frame #0 is the short frame corresponding to the control region of the system as the legacy short frame, and as a result, short frame #0 is not used and short frame #1 which is the next short frame may be used for the HARQ operation.

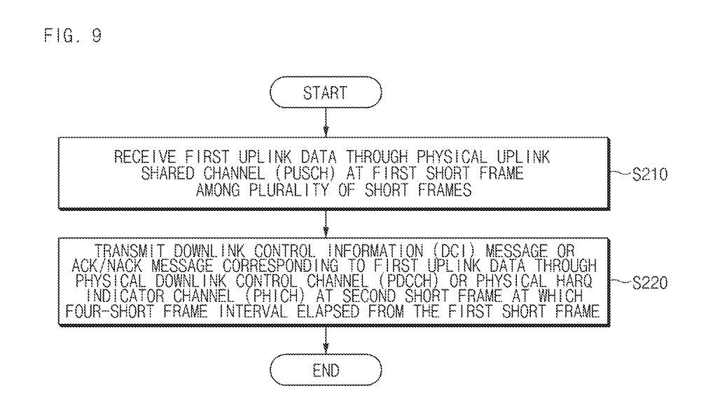

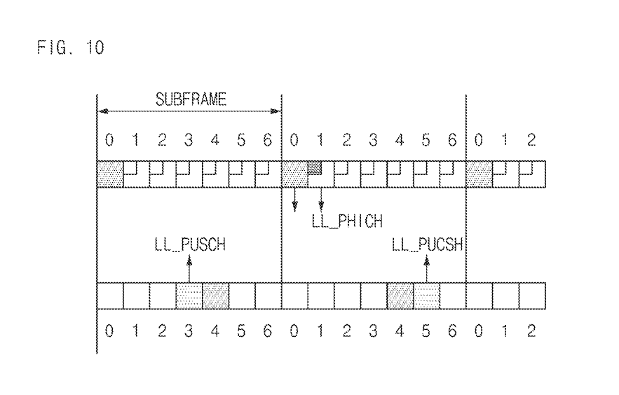

FIG. 9 is a flowchart illustrating an uplink HARQ operating method of the wireless communication system according to the exemplary embodiment of the present invention. FIG. 10 is a diagram illustrating the uplink HARQ operation of the wireless communication system according to the exemplary embodiment of the present invention.

First, referring to FIG. 9, the uplink HARQ operating method of the wireless communication system according to the exemplary embodiment of the present invention may include transmitting the first uplink data among the plurality of short frames through the physical uplink shared channel (PUSCH) at the first short frame (S210), and receiving the downlink control information (DCI) message or the ACK/NACK message corresponding to the first uplink data through the physical downlink control channel (PDCCH) or a physical HARQ indicator channel (PHICH) at the second short frame at which the four-short frame elapsed from the first short frame (S220) and when the second short frame is the legacy short frame, the next short frame may be set as the second short frame.

Hereinafter, steps S210 and S220 will be described in more detail with reference to FIGS. 6 and 10.

In step S210, the terminal 110 may transmit the first uplink data to the base station 120 through the low latency PUSCH (LL_PUSCH) at the first short frame (e.g., short frame #3). Herein, “LL_” may mean that the low latency characteristics which the wireless communication system 100 according to the exemplary embodiment of the present invention may obtain by using the subframe structure described with reference to FIGS. 3 and 4 are reflected.

In step S220, the terminal 110 may receive the DCI message or the ACK or NACK message from the base station 120 through the low latency PDCCH (LL_PDCCH) or the low latency PHICH (LL_PHICH) as the response to the first downlink data at the second short frame which the four-short frame interval elapsed from the first short frame (e.g., short frame #3). For example, in FIG. 10, a case of using the LL_PHICH is illustrated. Herein, “LL_” may mean that the low latency characteristics which the wireless communication system 100 according to the exemplary embodiment of the present invention may obtain by using the subframe structure described with reference to FIGS. 3 and 4 are reflected.

Herein, the third short frame may be set as short frame #1. That is, the third short frame at which the four-short frame interval elapsed from the second short frame (e.g., short frame #3) is short frame #0, but short frame #0 is the short frame corresponding to the control region of the system as the legacy short frame, and as a result, short frame #0 is not used and short frame #1 which is the next short frame may be used for the HARQ operation.

Meanwhile, short frame #4 of the uplink subframe illustrated in FIG. 10 may be allocated to a resource of physical random access channel (PRACH) or contention-based uplink transmission.

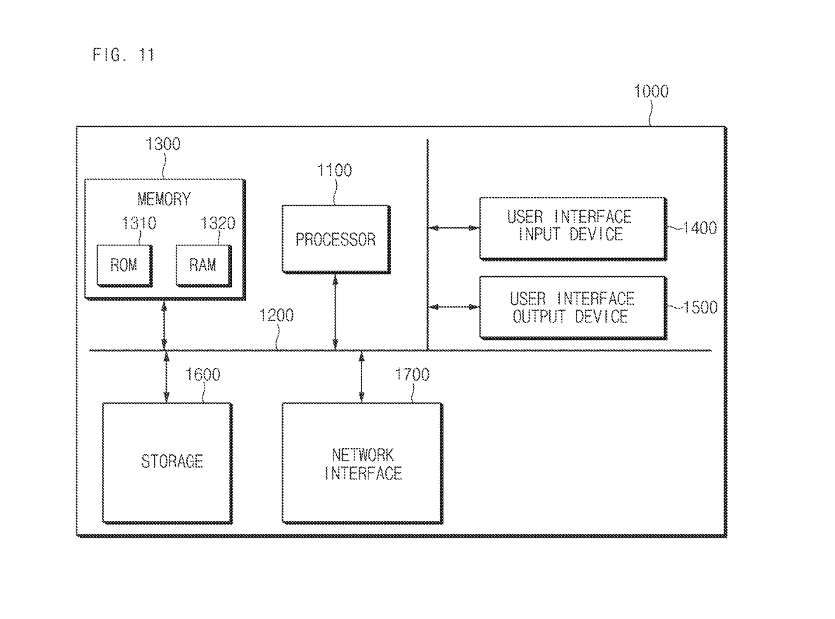

FIG. 11 is a block diagram of a computing system executing the HARQ operating method of the wireless communication system according to the exemplary embodiment of the present invention.

Referring to FIG. 11, the computing system 1000 may include at least one processor 1100, a memory 1300, a user interface input device 1400, a user interface output device 1500, a storage 1600, and a network interface 1700 connected through a system bus 1200.

The processor 1100 may be a semiconductor device that executes processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM, a flash memory, a ROM, an EPROM, an EEPROM, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in the user terminal. As yet another method, the processor and the storage medium may reside in the user terminal as individual components.

The above description just illustrates the technical spirit of the present invention and various changes and modifications can be made by those skilled in the art to which the present invention pertains without departing from an essential characteristic of the present invention.

Therefore, the exemplary embodiments disclosed in the present invention are used to not limit but describe the technical spirit of the present invention and the scope of the technical spirit of the present invention is not limited by the exemplary embodiments. The scope of the present invention should be interpreted by the appended claims and it should be analyzed that all technical spirit in the equivalent range thereto is intended to be embraced by the scope of the present invention.

What is claimed is:

1. A subframe structure of a wireless communication system, comprising:
a plurality of short frames defined as n (n<12, n is a natural number) OFDM symbol periods,
wherein a transmission time interval (TTI) is determined based on the plurality of short frames.

2. The subframe structure of claim 1, wherein the n is 2.

3. The subframe structure of claim 2, wherein the subframe includes a downlink subframe or an uplink subframe.

4. The subframe structure of claim 3, wherein the downlink subframe includes 6 data short frames and 1 legacy short frame.

5. The subframe structure of claim 4, wherein a first OFDM symbol of two OFDM symbols included in each of 6 data short frames includes control information of a corresponding data short frame.

6. The subframe structure of claim 3, wherein the uplink subframe includes 7 data short frames.

7. The subframe structure of claim 6, wherein each of 7 data short frames includes information for transferring uplink control information.

8. The subframe structure of claim 1, wherein the subframe is defined in a partial area in an available channel bandwidth.

9. The subframe structure of claim 1, wherein the subframe is defined as a time period of 1 ms.

10. An HARQ operating method of a wireless communication system using a subframe structure including a plurality of short frames defined as 2 OFDM symbol periods, in which a transmission time interval (TTI) is determined based on the plurality of short frames, the method comprising:
receiving first downlink data among a plurality of short frames through the physical downlink shared channel (PDSCH) at a first short frame;
transmitting an ACK/NACK message corresponding to the first downlink data through the physical uplink control channel (PUCCH) at a second short frame at which a four-short frame interval elapsed from the first short frame; and
receiving second downlink data at a third short frame through the PDSCH at which the four-short frame interval elapsed from the second short frame,
wherein when the third short frame is a legacy short frame, a next short frame is set as the third short frame.

11. The method of claim 10, wherein the subframe is a downlink subframe.

12. The method of claim 11, wherein the downlink subframe includes 6 data short frames and 1 legacy short frame.

13. The method of claim 12, wherein a first OFDM symbol of two OFDM symbols included in each of 6 data short frames includes control information of a corresponding data short frame.

14. An HARQ operating method of a wireless communication system using a subframe structure including a plurality of short frames defined as 2 OFDM symbol periods, in which a transmission time interval (TTI) is determined based on the plurality of short frames, the method comprising:
transmitting first uplink data through a physical uplink shared channel (PUSCH) at a first short frame among the plurality of short frames; and
receiving a downlink control information (DCI) message or an ACK/NACK message corresponding to the first uplink data through a physical downlink control channel (PDCCH) or a physical HARQ indicator channel (PHICH) at a second short frame at which a four-short frame interval elapsed from the first short frame,
wherein when the second short frame is a legacy short frame, a next short frame is set as the second short frame.

15. The method of claim 14, wherein the subframe is an uplink subframe.

16. The method of claim 15, wherein the uplink subframe includes 7 data short frames.

17. The method of claim 16, wherein each of 7 data short frames includes information for transferring uplink control information (UCI).
